(19) United States
(12) Patent Application Publication
(10) Pub. No.: US 2006/0064406 A1
(43) Pub. Date: Mar. 23, 2006

(54) Method and computer program product for accessing an alternative web page when a desired web page is unavailable

(75) Inventors: Nathanael Ferguson Ehrich, Raleigh, NC (US); Jason Christian Plurad, Raleigh, NC (US); Laquicia Shianna Russ, Durham, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/947,913

(22) Filed: Sep. 23, 2004

(51) Int. Cl. G06F 17/30

(52) U.S. Cl. 707/3

(57) ABSTRACT

A user specifies sets of web browser bookmarks or favorites, which may have topical affinity. Each member of a set is assigned a priority. When the user selects a particular bookmark in a set, or more generally selects the set using an alias such as a folder heading, the web browser attempts to access the particular bookmarked page, or more generally the highest priority web page in the set. If the page is unavailable, the web browser automatically selects the next-highest-priority web page, and attempts to access that page, progressing through the set in this manner by priority until an available web page is found.

### BACKGROUND OF THE INVENTION

The present invention relates to the field of information technology, and is advantageously applicable to Internet technology and program products such as Web browsers.

An enormous number of web pages are now available through the Internet. As a result, it has become increasingly difficult to find any particular page. In response to this problem, web browsers routinely provide the user with the option of marking pages of interest so that the user may conveniently return to these pages without conducting a new search each time access is desired. Pages are marked by recording their uniform resource locators (URLs) in libraries, which recorded URLs are often called “bookmarks” or “favorites.”

In some circumstances, however, a user may be more interested in the generic nature of a bookmarked page rather than the particular page itself. For example, a user may be interested in any trustworthy reference work that associates the names of recording artists with song titles, rather than a particular reference work. This user may conduct a search, find an acceptable reference, and bookmark the web page of the reference for future use.

When the same user later tries to return to the bookmarked web page, he or she may find that the bookmarked page is unavailable, due to, for example, a server failure, Internet congestion, address changes, obsolescence, or the like. At this point, the user may return to the library to select a bookmark for an alternative reference, or, if no alternative comes readily to mind, link a search engine to begin anew. In effect, this defeats the convenience offered by bookmarks.

Thus, a need exists for a more convenient way of providing a user with an alternative web page when a desired web page is unavailable.

### SUMMARY

A user specifies a set of web browser bookmarks or favorites, which may have topical affinity. Each member of the set is assigned a priority. When the user selects a particular bookmark in a set, or more generally selects the set using an alias such as a folder heading, the web browser attempts to access the web page identified by the particular bookmark, or more generally to access the highest priority web page in the set. If the selected web page is unavailable, the web browser automatically selects the next-highest priority web page and attempts to access that page, progressing through the set in this manner by priority until a web page is found that is available.

### BRIEF DESCRIPTION OF THE DRAWING

FIG. 1 is a flowchart that shows an exemplary method according to the present invention for accessing an alternative web page when a desired web page is unavailable.

### DETAILED DESCRIPTION

The present invention will now be described more fully hereinafter, with reference to the accompanying drawing. The invention may, however, be embodied in many different forms, and should not be construed as limited to the embodiments set forth herein; rather, these embodiments are provided so that the disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java7, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to a flowchart illustration. It will be understood that each block of the flowchart illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart.

According to the invention, web browser bookmarks may be organized into sets that correspond to content, or content provider, and the like. Thus, the user preassociates web pages with one another, by including them in the same set. In a sense, such sets may be similar to bookmarks gathered under folders. Unlike with folders, however, the categories or headings of the sets may themselves serve as aliases, meaning that a category or heading may be selected to direct the browser to a web page.

Within a set of bookmarks, the various bookmarks are given priorities with respect to each other. The priorities are specified by the user, and may be specified using implicit indicators or explicit indicators.

For example, suppose a set having the alias “music” includes bookmarks to the three web pages goodmusic.com, bettermusic.com, and bestmusic.com. The user may wish to assign the highest priority to bestmusic.com, and the lowest to goodmusic.com. These priorities may be expressed explicitly by ranking indicators such as high, medium, and low, or by numerical weights, or in correspondence with letters of the alphabet, and so forth. Alternatively, the priorities may be expressed implicitly by the order in which the bookmarks appear in a display of the members of the set, or by their relative positions in a display of the member of the set (for example, using indentations), and so forth. In any case, the priorities are set by the user, and recorded in association with the various bookmarks.

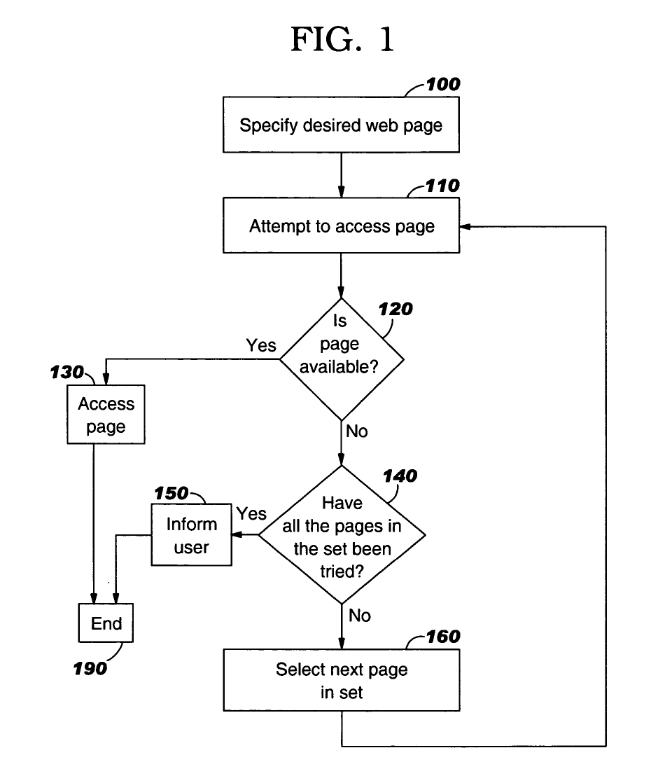

As shown in FIG. 1, the user specifies a desired web page (step 100), for example by mouse clicking in a bookmark library pull-down. Here, the user may specify the desired web page generally, by selecting an alias as just described, or specifically, by selecting a particular bookmark in a set. When an alias is used, it may be assumed that the user desires to access the bookmarked web page having the highest priority in the set identified by the alias.

The browser then attempts to access the desired web page (step 110). A determination is made as to whether the web page is available, according to the success or lack thereof encountered by the browser (step 120). If the web page is available, the page is accessed (step 130), and the process as described here ends conventionally (step 190).

A page may be judged unavailable when it does not respond to the browser due to a slow connection or a server problem; when there is a server error of the type 500; when the server is not found, giving rise to a type-404 error; and so forth. If the web page is unavailable, the browser determines whether all of the web pages in the set that includes the desired web page have been tried (step 140). If all of the web pages in the set have been tried without success, i.e., without finding an available page, the browser may so inform the user (step 150), and the process ends (step 190).

If some of the web pages in the set are as yet untried, the browser selects the next web page in the set (step 160). Here, “next” means the web page having the highest priority among the untried web pages. The browser then attempts to access the selected web page (step 110), and the process repeats as described above until all of the web pages in the set have been tried.

Although the invention has been described above with reference to an exemplary embodiment that centers on a web browser, the invention is applicable as well to portlets that appear in a web portal page, wherein an alternative portlet having the highest priority is loaded into the portal when a desired portlet is unavailable.

Although the foregoing has described methods and computer program products for accessing an alternative web page or portlet when a desired web page or portlet is unavailable, the description of the invention is illustrative rather than limiting; the invention is limited only by the claims that follow.

We claim:

1. A method for accessing an alternative web page when a desired web page is unavailable, said method comprising:
attempting to access a first web page specified by a user; and, if the first web page is unavailable, automatically selecting a second web page preassociated by the user with the first web page.

2. The method of claim 1, wherein the first web page has a first bookmark included in a set of bookmarks specified by the user, and the second web page has a second bookmark included in the set of bookmarks.

3. The method of claim 2, wherein the first web page is specified by the user through an alias that points to a bookmark in the set of bookmarks.

4. The method of claim 2, wherein each bookmark of the set of bookmarks is associated with a priority specified by the user.

5. The method of claim 4, wherein the second web page is selected according to priorities of the bookmarks.

6. The method of claim 4, wherein priorities of the bookmarks are specified using explicit indicators.

7. The method of claim 4, wherein priorities of the bookmarks are specified using implicit indicators.

8. A computer program product for accessing an alternative web page when a desired web page is unavailable, the computer program product comprising a computer readable medium having computer readable program code embedded therein, the computer readable program code comprising:
computer readable program code configured to attempt to access a first web page specified by a user; and, if the first web page is unavailable, to automatically select a second web page preassociated by the user with the first web page.

9. The computer program product of claim 8, wherein the first web page has a first bookmark included in a set of bookmarks specified by the user, and the second web page has a second bookmark included in the set of bookmarks.

10. The computer program product of claim 8, wherein the first web page is specified by the user through an alias that points to a bookmark in the set of bookmarks.

11. The computer program product of claim 9, wherein each bookmark of the set of bookmarks is associated with a priority specified by the user.

12. The computer program product of claim 11, wherein the second web page is selected according to priorities of the bookmarks.

13. The computer program product of claim 11, wherein priorities of the bookmarks are specified using explicit indicators.

14. The computer program product of claim 11, wherein priorities of the bookmarks are specified using implicit indicators.

15. A method for loading an alternative web portlet in a web portal when a desired web portlet is unavailable, said method comprising:
attempting to load a first web portlet specified by a user into a portal; and, if the first web portlet is unavailable, automatically selecting a second web portlet preassociated by the user with the first web portlet.

16. The method of claim 15, wherein the first portlet has a URL included in a set of URLs specified by the user, and the second portlet has a second URL included in the set of URLs.

17. The method of claim 16, wherein each URL of the set of URLs is associated with a priority specified by the user.

18. The method of claim 16, wherein the second portlet is selected according to priorities of the URLs.
